(19) United States
(12) Patent Application Publication
(10) Pub. No.: US 2018/0370149 A1
(43) Pub. Date: Dec. 27, 2018

(54) ADDITIVE MANUFACTURING APPARATUS, MANUFACTURING METHOD OF MANUFACTURED OBJECT, PROGRAM AND RECORDING MEDIUM

(71) Applicant: CANON KABUSHIKI KAISHA, Tokyo (JP)

(72) Inventor: Yoshihiro Ishibe, Sakura-shi (JP)

(21) Appl. No.: 16/121,164

(22) Filed: Sep. 4, 2018

Related U.S. Application Data
(63) Continuation of application No. PCT/JP2017/004858, filed on Feb. 10, 2017.

(30) Foreign Application Priority Data
Mar. 9, 2016 (JP) 2016-046319

(51) Int. Cl. B29C 64/393; B33Y 10/00; B33Y 30/00; B33Y 50/02; B29C 64/129; B29C 64/277; B29C 64/227

(52) U.S. Cl. CPC B29C 64/393; B33Y 10/00; B33Y 30/00; B29C 64/227; B29C 64/129; B29C 64/277; B33Y 50/02

(57) ABSTRACT

In order to improve shape accuracy of a manufactured object, there is provided an additive manufacturing apparatus which comprises: a light source; a vessel, having a light transmitting portion through which light of the light source is transmitted, for storing a photosetting resin material to be cured by the light of the light source; an image forming element for forming image light corresponding to image data from the incident light from the light source; a projection optical system for projecting the image light on a manufacturing position inside the vessel through the light transmitting portion; a moving member for moving a manufacturing layer cured by the image light at the manufacturing position, in a separation direction away from the light transmitting portion; and a controlling unit for controlling the image forming element.

### CROSS-REFERENCE TO RELATED APPLICATIONS

This application is a Continuation of International Patent Application No. PCT/JP2017/004858, filed Feb. 10, 2017, which claims the benefit of Japanese Patent Application No. 2016-046319, filed Mar. 9, 2016, both of which are hereby incorporated by reference herein in their entirety.

### BACKGROUND OF THE INVENTION

### Field of the Invention

The present invention relates to a technique of manufacturing a three-dimensional manufactured object by curing a photosetting (photocurable) resin material.

### Description of the Related Art

In recent years, various additive (three-dimensional) manufacturing techniques have been proposed in order to cope with trial manufacture of products at the time of product development and small-lot production of products. In such additive (three-dimensional) manufacture, image data indicating a cross-section shape of a manufactured object at a predetermined height step is generated based on three-dimensional shape data, and a manufacturing layer having a shape corresponding to the image data is laminated, thereby manufacturing a manufactured object. As one of such additive (three-dimensional) manufacturing methods, a manufacturing method using a photosetting resin material has been proposed (U.S. Patent Application Publication No. 2015/0054198).

In U.S. Patent Application Publication No. 2015/0054198, a resin material is cured by scanning with a laser beam, and a cured manufacturing layer is laminated to form a manufactured object. However, in the manufacturing method of laser beam scanning as disclosed in U.S. Patent Application Publication No. 2015/0054198, it takes time to manufacture the manufactured object.

In view of this, instead of the laser beam scanning, it is conceivable to shorten the time required for the manufacture by performing batch exposure using an image forming element having a plurality of pixels arranged in an array shape and wholly curing the manufacturing layer.

In the image forming element of this type, it is constituted to be able to control output of light for each pixel by independently driving each pixel. Therefore, by using the image forming element, a manufactured object is formed with accuracy corresponding to resolution of this image forming element.

However, in an additive manufacturing apparatus using the above image forming element, shape accuracy of the manufactured object is determined by the resolution of the image forming element, that is, a pixel interval of the image forming element. Therefore, even if resolution of original image data is high, when the resolution of the image forming element is lower than the resolution of the image data, the shape accuracy of the manufactured object is low.

An object of the present invention is to improve the shape accuracy of the manufactured object.

### SUMMARY OF THE INVENTION

An additive manufacturing apparatus according to the present invention is characterized by comprising: a light source; a vessel configured to have a light transmitting portion through which light of the light source is transmitted, and store a photosetting resin material to be cured by the light of the light source; an image forming element configured to form image light corresponding to sequentially switched image data, from the incident light from the light source; a projection optical system configured to project the image light on a manufacturing position inside the vessel through the light transmitting portion; a moving member configured to move a manufacturing layer cured by the image light at the manufacturing position, in a separation direction away from the light transmitting portion; and a controlling unit configured to control the image forming element, wherein: the image forming element is configured to have a plurality of pixels in which light to be output to the projection optical system can be adjusted individually; a profile of the light of each of the pixels passing through the projection optical system is set to a state that a projection region is expanded at the manufacturing position as compared with a profile in a state that imaging is performed at the manufacturing position; the controlling unit is configured to divide the image data having resolution higher than resolution of the image forming element into a section region corresponding to each of the pixels of the image forming element; and, in each period that the image light is projected, the controlling unit is configured to control, to halftone, the light output from, among the plurality of pixels, the pixel corresponding to the section region including pixel data indicating a manufacturing portion and pixel data indicating a portion not the manufacturing portion.

Besides, a manufactured object manufacturing method according to the present invention is characterized in that a photosetting resin material to be cured by light of a light source is stored in a vessel having a light transmitting portion, an image forming element which has a plurality of pixels in which light to be output to an projection optical system can be adjusted individually is controlled by a controlling unit to form image light corresponding to sequentially switched image data from the incident light from the light source, the image light is projected by the projection optical system on a manufacturing position inside the vessel through the light transmitting portion, and a three-dimensional manufactured object is manufactured while moving, by a moving member, a manufacturing layer cured at the manufacturing position in a separation direction away from the light transmitting portion, and the manufactured object manufacturing method is further characterized by comprising: setting a profile of the light of each of the pixels passing through the projection optical system to a state that a projection region is expanded at the manufacturing position as compared with a profile in a state that imaging is performed at the manufacturing position; dividing, by the controlling unit, the image data having resolution higher than resolution of the image forming element into a section region corresponding to each of the pixels of the image forming element; and, in each period that the image light is projected, controlling, by the controlling unit, the light output from, among the plurality of pixels, the pixel corresponding to the section region including pixel data indicating a manufacturing portion and pixel data indicating space, to halftone.

According to the present invention, since the manufactured object can be manufactured with resolving power higher than resolving power corresponding to the resolution of the image forming element, shape accuracy of the manufactured object improves.

Further features of the present invention will become apparent from the following description of exemplary embodiments with reference to the attached drawings.

### BRIEF DESCRIPTION OF THE DRAWINGS

FIG. 1 is an explanatory diagram for describing a constitution of an additive manufacturing apparatus according to an embodiment.

FIG. 2A is a plan view for describing an image forming element according to the embodiment, and FIG. 2B is a plan view for describing the image forming element and a driving mechanism according to the embodiment.

FIG. 3A is a schematic diagram for describing a state that a manufacturing position and an image forming position coincides with each other, and FIG. 3B is a schematic diagram for describing a state that the manufacturing position and the image forming position are shifted (or deviated) from each other.

FIG. 4A is a schematic diagram for describing four adjacent pixels out of a plurality of pixels of the image forming element, and FIG. 4B is a schematic diagram for describing pixel data corresponding to the four pixels in FIG. 4A.

FIGS. 5A and 5B are graphs each of which describes a light amount distribution of light projected by each pixel at a manufacturing position when the image forming position is made to coincide with the manufacturing position.

FIGS. 6A, 6B and 6C are graphs each of which describes a light amount distribution of light projected by each pixel at the manufacturing position in a case where a duty ratio is changed when the image forming position is shifted with respect to the manufacturing position.

FIGS. 7A, 7B and 7C are graphs each of which describes a light amount distribution of light projected by each pixel at the manufacturing position when a shift amount of the image forming position with respect to the manufacturing position is changed.

FIG. 8 is a flow chart for describing a manufacturing method of a manufactured object according to the embodiment.

FIGS. 9A and 9B are schematic diagrams respectively for describing other examples of a manufacturing unit of the additive manufacturing apparatus.

### DESCRIPTION OF THE EMBODIMENTS

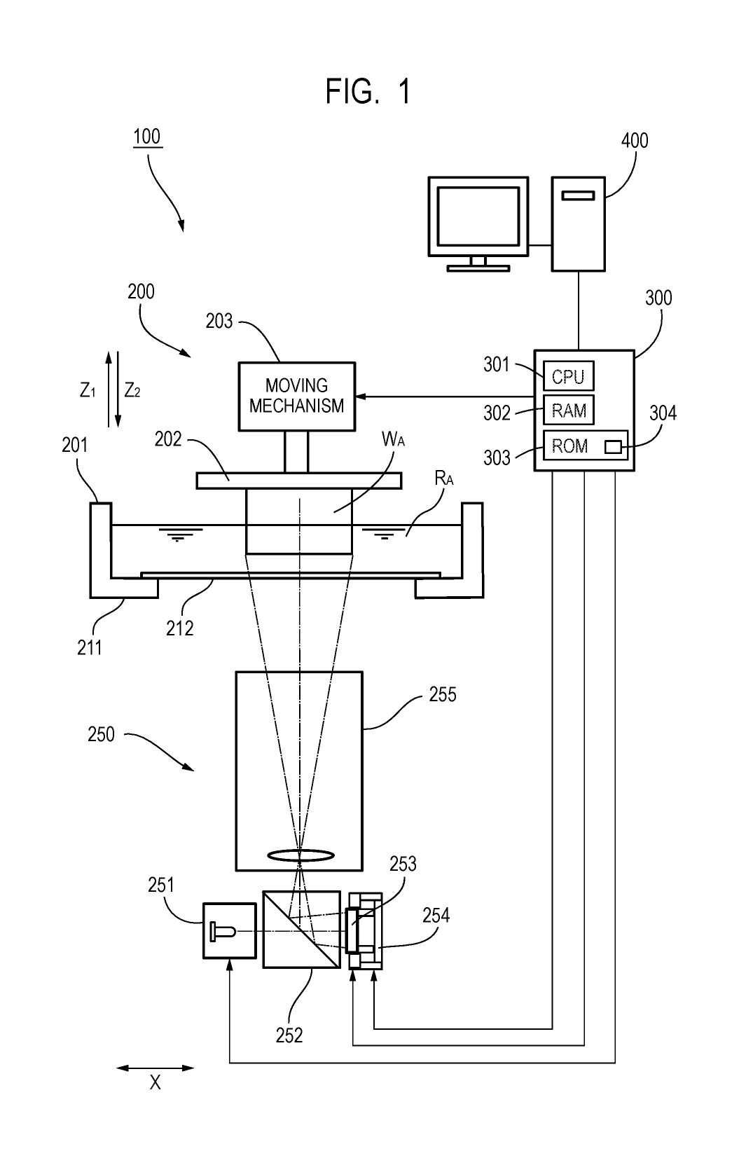

Hereinafter, preferred embodiments of the present invention will be described in detail with reference to the attached drawings. FIG. 1 is an explanatory diagram for describing a constitution of an additive manufacturing apparatus according to the embodiment. An additive manufacturing apparatus 100 cures a photosetting (photocurable) resin material with image light and sequentially laminates cured manufacturing layers, thereby forming a three-dimensional manufactured object. Hereinafter, a case where light to be used for manufacturing the three-dimensional manufactured object is ultraviolet rays and a resin material cured by the ultraviolet rays is used as the photosetting resin material will be described as an example.

The additive manufacturing apparatus 100 comprises a manufacturing unit 200, and a controlling device 300 which serves as a controlling unit for controlling the manufacturing unit 200. An image processing apparatus 400 which is an external computer is connected to the controlling device 300.

The manufacturing unit 200 comprises a vessel 201, a holding plate 202 which is a moving member (holding member), a moving mechanism 203 which drives the holding plate 202, and a projecting unit 250.

The vessel 201, which stores therein a liquid photosetting resin material R_{A}, is formed with an open upper portion. The vessel 201 is constituted by a vessel main body 211 and a light transmitting member 212 which is a light transmitting portion through which light passes.

The photosetting resin material R_{A} is a resin material which is cured when irradiated with light (ultraviolet rays) having an amount of light equal to or larger than a light amount threshold. Therefore, since only the portion irradiated with light having the amount of light equal to or larger than the light amount threshold can be cured, a manufactured object can be formed by light irradiation.

The light transmitting member 212 is a window member through which image light is transmitted into the vessel 201. The light transmitting member 212 is attached to the vessel main body 211 so as to close the opening formed in the bottom portion of the vessel main body 211.

In the present embodiment, the light transmitting member 212 is a light oxygen transmitting member through which light (ultraviolet rays) and oxygen are transmitted. For example, the light transmitting member 212 is a thin fluororesin plate (e.g., Teflon™ AF2400) which is substantially transparent to ultraviolet rays. The light transmitting member 212 transmits oxygen in the air to form an oxygen-rich atmosphere at the surface interface with the photosetting resin material R_{A}, and thus prevents curing (radical polymerization reaction) of the photosetting resin material R_{A} due to ultraviolet rays. That is, the photosetting resin material R_{A} is a resin material which is cured by ultraviolet rays and hinders from being cured in an oxygen-rich environment. Thus, a dead zone (dead band) in which the photosetting resin material R_{A} is not cured with ultraviolet rays is formed in the vicinity of the light transmitting member 212 between a manufactured object (i.e., an intermediate object in the middle of manufacturing) W_{A} and the light transmitting member 212. Thus, the manufactured object (intermediate object) W_{A} is pulled upward without adhering to the light transmitting member 212, so that continuous manufacturing (molding) of the manufactured object W_{A} can be performed.

Incidentally, it should be noted that the oxygen passing through the light transmitting member 212 is oxygen in the air. However, it is also possible to arrange an oxygen supplying device (nozzle) in the vicinity of the light transmitting member 212 so as to supply oxygen to the light transmitting member 212. Moreover, it is possible to perform the manufacturing under a high-pressure oxygen atmosphere.

Above the vessel 201, the holding plate 202 is arranged to face the light transmitting member 212.

The moving mechanism 203, which is constituted by a pulse motor, a ball screw and the like, drives the holding plate 202 at an arbitrary speed or an arbitrary pitch under the control of the controlling device 300. More specifically, the moving mechanism 203 drives and moves the holding plate 202 in a separation direction (Z₁ direction, i.e., upward direction) away from the light transmitting member 212 and also drives and moves the holding plate 202 in an approach direction (Z₂ direction opposite to Z₁ direction, i.e., downward direction) close to the light transmitting member 212. While manufacturing the manufactured object W_{A}, the moving mechanism drives the holding plate 202 in the Z₁ direction. Thus, the holding plate 202 is continuously pulled upward by the moving mechanism 203 during the manufacture of the manufactured object W_{A}.

The projecting unit 250 is disposed below the vessel 201. The projecting unit 250 comprises a light source 251, a beam splitter 252, an image forming element (light modulating element) 253, a driving mechanism 254 and a projection optical system 255. Incidentally, the projecting unit 250 may further comprise another optical element for changing an optical path as needed.

The light source 251, the beam splitter 252 and the image forming element 253 are arranged in series in the horizontal direction (X direction), and the projection optical system 255 is disposed above (in Z₁ direction) the beam splitter 252. The projection optical system 255 is disposed to face the light transmitting member 212.

The light source 251 is a light source unit which comprises a light source device (e.g., LED (light-emitting diode) or high-pressure mercury lamp) for emitting ultraviolet rays as light, and a not-illustrated irradiation optical system. The light source irradiates the image forming element 253 with ultraviolet rays through the beam splitter 252.

The beam splitter 252 transmits the light emitted from the light source 251, and reflects the image light from the image forming element 253 to the projection optical system 255.

The projection optical system 255, which comprises one or a plurality of projection lenses, projects the light output from the image forming element to an image forming position which is a conjugate position with the image forming element 253. That is, the projection optical system 255 projects the image light (i.e., the light having the amount of light equal to or larger than the light amount threshold) to the manufacturing position in the vessel through the light transmitting member 212. The portion which is irradiated with the light at the manufacturing position in the photosetting resin material R_{A} stored in the vessel 201 is cured, so that the manufacturing layer is formed.

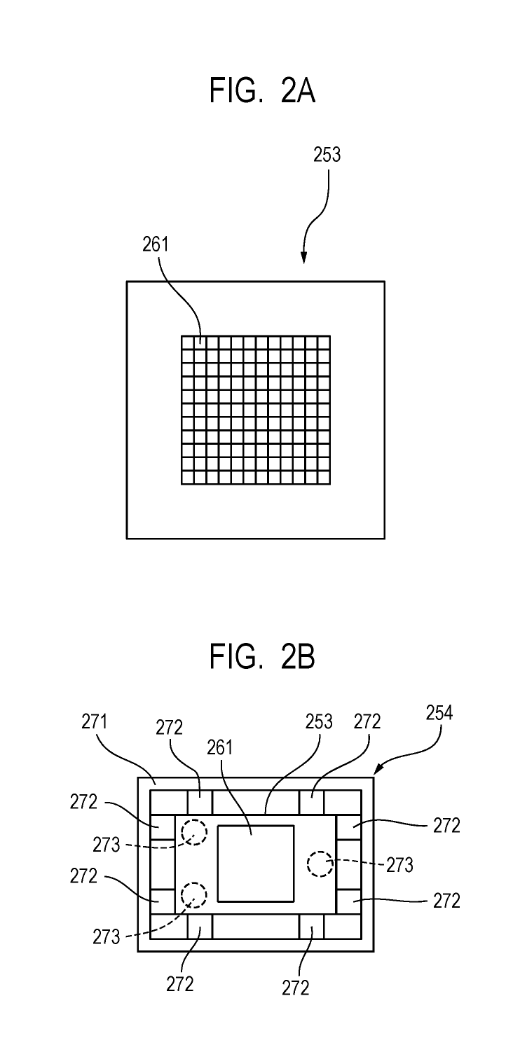

FIG. 2A is a plan view for describing the image forming element according to the embodiment. The image forming element 253 has a plurality of pixels 261 in which the light to be output to the projection optical system 255 can be adjusted individually. Under the control of the controlling device 300, the image forming element forms the image light corresponding to image data, from the light emitted by the light source 251.

The plurality of pixels 261 are arranged at equal intervals in an array shape. Each pixel 261 can be individually switched between an ON state that incident light is output to the projection optical system 255 and an OFF state that incident light is not output to the projection optical system 255. The controlling device 300 individually controls the ON state and the OFF state of each pixel 261.

In the present embodiment, the image forming element 253 is a DMD (digital micromirror device) element, and each pixel 261 of the DMD element is constituted by a minute reflecting mirror which is movable in two angular states. Each pixel 261 can perform binary control of the ON state and the OFF state. Here, by duty control of performing switching between the ON state and the OFF state at high speed, it is possible to express halftone. The image forming element 253 forms the image light corresponding to the sequentially switched image data from the incident light from the light source 251, under the control of the controlling device 300.

Although the case where the image forming element 253 is the DMD element will be described in the embodiment, the present invention is not limited to this. Namely, a liquid crystal panel (e.g., LCOS™) may be used as the image forming element 253. It is possible to express halftone by switching the pixels at high speed. Further, the present invention is not limited to the reflection type image forming element, but may be a transmission type image forming element. In this case, a state that each pixel transmits light corresponds to an ON state, and a state that each pixel does not transmit light corresponds to an OFF state. Besides, an image forming element such as a liquid crystal panel capable of expressing halftone by adjusting a light transmission amount and a light reflection amount may be used.

As described above, each pixel 261 is constituted so that the light output to the projection optical system 255 can be individually adjusted (gradation expression can be performed).

The driving mechanism 254 holds the image forming element 253 so as to move at least one of the image forming element 253 and the projection optical system 255, i.e., the image forming element 253 in this case. In the present embodiment, the driving mechanism 254 moves the image forming element 253 in the X direction. Incidentally, when moving the projection optical system 255, it may be constituted to move the projection optical system 255 in the Z₁ and Z₂ directions. By moving at least one of the image forming element 253 and the projection optical system 255, it is possible to shift the image forming position of the light passing through the projection optical system 255 in the Z₁ and Z₂ directions with respect to the manufacturing position.

FIG. 2B is a plan view for describing the image forming element and the driving mechanism according to the embodiment. The driving mechanism 254 comprises a housing 271, and a plurality of piezoelectric elements 272 and 273 supported by the housing 271. The piezoelectric elements 272 and 273 support and fix the image forming element 253. The controlling device 300 drives and controls each of the piezoelectric elements 272 and 273 so that the image forming element 253 can be moved in the vertical direction, the horizontal direction, the rotation direction around the vertical axis, and the tilt direction with respect to the housing 271. More specifically, the image forming element 253 can be moved in the horizontal direction and in the rotation direction around the vertical axis by the piezoelectric element 272 and can be moved in the vertical direction and in the tilt direction by the piezoelectric element 273.

Accordingly, by driving the piezoelectric element 273, the image forming element 253 is moved in the vertical direction (X direction in FIG. 1) with respect to the housing 271, so that it is possible to shift the image forming position of the image light passing through the projection optical system 255 in the Z₁ and Z₂ directions with respect to the manufacturing position.

In the present embodiment, since it suffices that the image forming element 253 can be moved in the vertical direction with respect to the housing 271, the piezoelectric element 272 may be omitted.

The image processing apparatus 400 obtains a plurality of image data to be exposed on the photosetting resin material for each manufacturing region of the manufactured object W_{A} in increments of a predetermined height, based on three-dimensional shape design data of the manufactured object W_{A}. Then, the image processing apparatus 400 outputs moving image data composed of the plurality of image data to the controlling device 300.

Each image data is binarized image data, and is a set of pixel data indicating the manufacturing portion and pixel data indicating a portion which is not the manufacturing portion, i.e., a space portion.

The controlling device 300 inputs the moving image data in which the image data of each manufacturing layer of the manufactured object W_{A} is arranged in time series, from the image processing apparatus 400. Then, the controlling device 300 controls the light source 251, the moving mechanism 203, the image forming element 253 and the driving mechanism 254, so that the holding plate 202 is continuously (or intermittently) pulled upward at speed synchronized with the manufacture of the manufacturing layer based on the moving image data. Thus, the additive manufacture is performed such that the manufactured object W_{A} of which the upper end is held by the holding plate 202 is grown downward.

The controlling device 300 is constituted by a computer comprising a CPU (central processing unit) 301, a RAM (random access memory) 302 having a working area to be used for calculation of the CPU 301, and a ROM (read-only memory) 303. The ROM 303 is a recording medium on which a program 304 has been recorded, and is, for example, a rewritable nonvolatile memory such as an EEPROM (electrically erasable programmable read-only memory). The CPU 301 reads out the program 304 recorded in the ROM 303 to comprehensively control the manufacturing unit 200, thereby performing various processes.

Incidentally, the program 304 may be recorded on any recording medium as long as it is a computer readable recording medium. For example, as a recording medium for supplying the program 304, it may be possible to use a nonvolatile memory, a recording disk, an external storage device or the like. More specifically, as the recording medium, it is possible to use a flexible disk, a hard disk, an optical disk, a magneto-optical disk, a CD-ROM (compact disk read-only memory), a CD-R (compact disk recordable), a magnetic tape, a USB (universal serial bus) memory or the like.

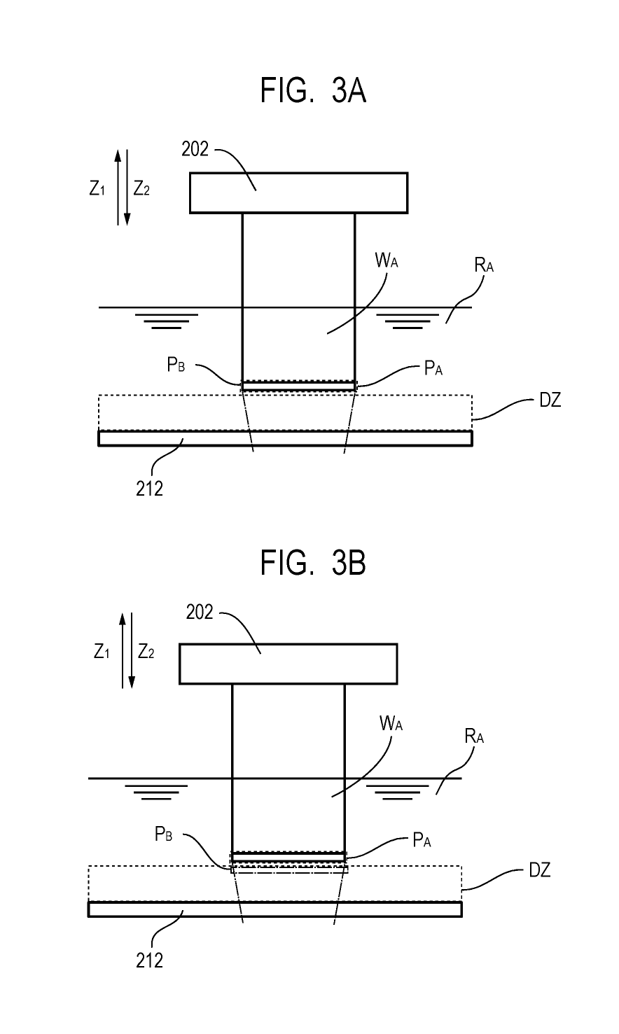

FIG. 3A is a schematic diagram for describing a state that the manufacturing position and the image forming position coincides with each other, and FIG. 3B is a schematic diagram for describing a state that the manufacturing position and the image forming position are shifted (or deviated) from each other.

As illustrated in FIGS. 3A and 3B, a manufacturing position P_{A} is a position of the lower end of the manufactured object (intermediate object) W_{A} and is a position located above a dead zone DZ. The photosetting resin material R_{A} is cured at the manufacturing position P_{A} by one-shot exposure of the image light, thereby forming the manufacturing layer. Then, the manufactured object W_{A} (i.e., manufacturing layer) is moved in the Z₁ direction and the image light based on next image data is exposed, thereby forming a next manufacturing layer.

At this time, if the manufacturing position P_{A} and an image forming position P_{B} of the image light passing through the projection optical system 255 are made to coincide with each other as illustrated in FIG. 3A, the ultraviolet ray imaged at the manufacturing position P_{A} is irradiated.

When the image forming element 253 is moved by the driving of the driving mechanism 254, as illustrated in FIG. 3B, the image forming position P_{B} of the image light is shifted in the Z₂ direction (or Z₁ direction) with respect to the manufacturing position P_{A}, so that blurred image light occurs at the image forming position P_{A}. That is, at the manufacturing position P_{A}, the projection region formed by a certain pixel 261 widens and thus overlaps the projection region formed by another pixel 261.

Generally, in case of manufacturing a manufactured object by binary control, as illustrated in FIG. 3A, the manufacture is performed in the state that the image forming position P_{B} coincides with the manufacturing position P_{A}.

Here, the resolution (the number of pixels) of each image data created by the image processing apparatus 400 is higher than the resolution (the number of pixels) of the image forming element 253. In other words, the image forming element 253 uses the resolution lower than the resolution of each image data. In a case where all the pixels 261 of the image forming element 253 are controlled by normal binary control, shape accuracy of the manufacturing layer manufactured according to the image data becomes low corresponding to the resolution of the image forming element 253.

Therefore, in the present embodiment, as illustrated in FIG. 3B, a defocused state is set. Further, for the pixel 261 corresponding to the edge of the manufacturing layer, brightness modulation is performed by duty control to represent halftones, thereby controlling a manufacturing width formed in the pixels 261. Hereinafter, a principle of such control will be described in detail.

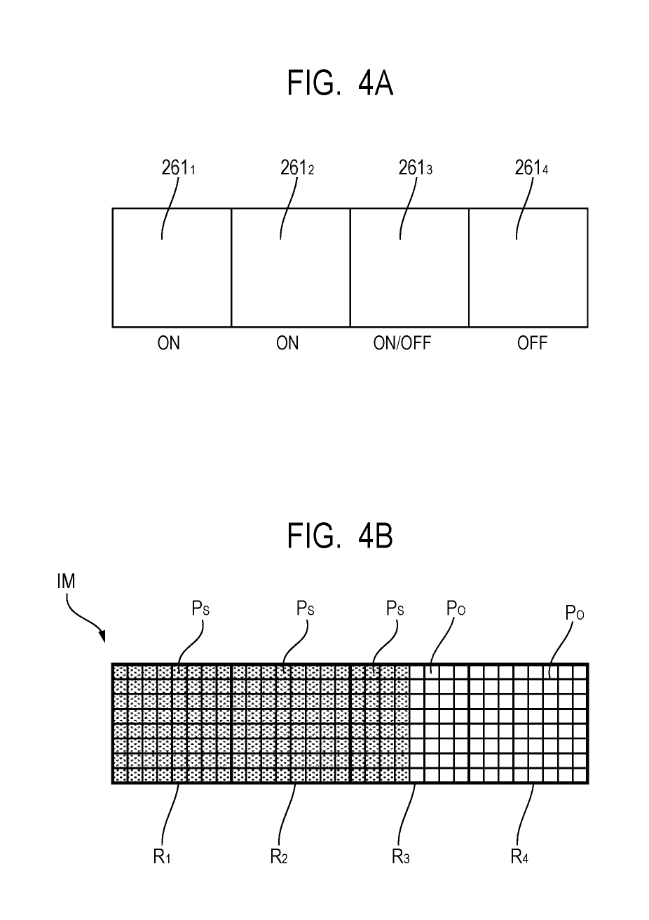

FIG. 4A is a schematic diagram for describing four adjacent pixels out of the plurality of pixels of the image forming element. As illustrated in FIG. 4A, four pixels 261₁, 261₂, 261₃ and 261₄ are arranged adjacently.

FIG. 4B is a schematic diagram for describing the pixel data corresponding to the four pixels of FIG. 4A in the image data forming one manufacturing layer. As illustrated in FIG. 4B, the resolution of image data IM is higher than the resolution of the image forming element 253. Therefore, the image data IM is divided (partitioned) into section regions R₁, R₂, R₃ and R₄ in correspondence with the pixels 261₁, 261₂, 261₃ and 261₄ of the image forming element 253. A plurality of pixel data are included in each section region. Here, in FIG. 4B, the hatched portion corresponds to pixel data P_{S} indicating the manufacturing portion, and the hollow portion corresponds to pixel data P_{O} indicating the space portion which is not the manufacturing portion.

Only the pixel data P_{S} are included in the section regions R₁ and R₂, and only the pixel data P_{O} are included in the section region R₄. On the other hand, the pixel data P_{S} and the pixel data P_{O} are mixedly included in the section region R₃, and this section region R₃ corresponds to the edge of the manufacturing layer (manufactured object).

Here, the controlling device 300 controls the operation of each pixel 261 by the control selected from among ON control for controlling to the ON state, OFF control for controlling to the OFF state, and the duty control (also referred to as brightness modulation control) for alternately switching the control between the ON state and the OFF state. It should be noted that the ON control and the OFF control are the binary control.

Therefore, in the case of FIG. 4B, the ON control is performed to the pixel 261₁ corresponding to the section region R₁, the ON control is performed to the pixel 261₂ corresponding to the section region R₂, the OFF control is performed to the pixel 261₄ corresponding to the section region R₄, and the duty control is performed to the pixel 261₃ corresponding to the section region R₃.

Here, as a comparative example, a case where the image forming position P_{B} of the light passing through the projection optical system 255 coincides with the manufacturing position P_{A} will be described.

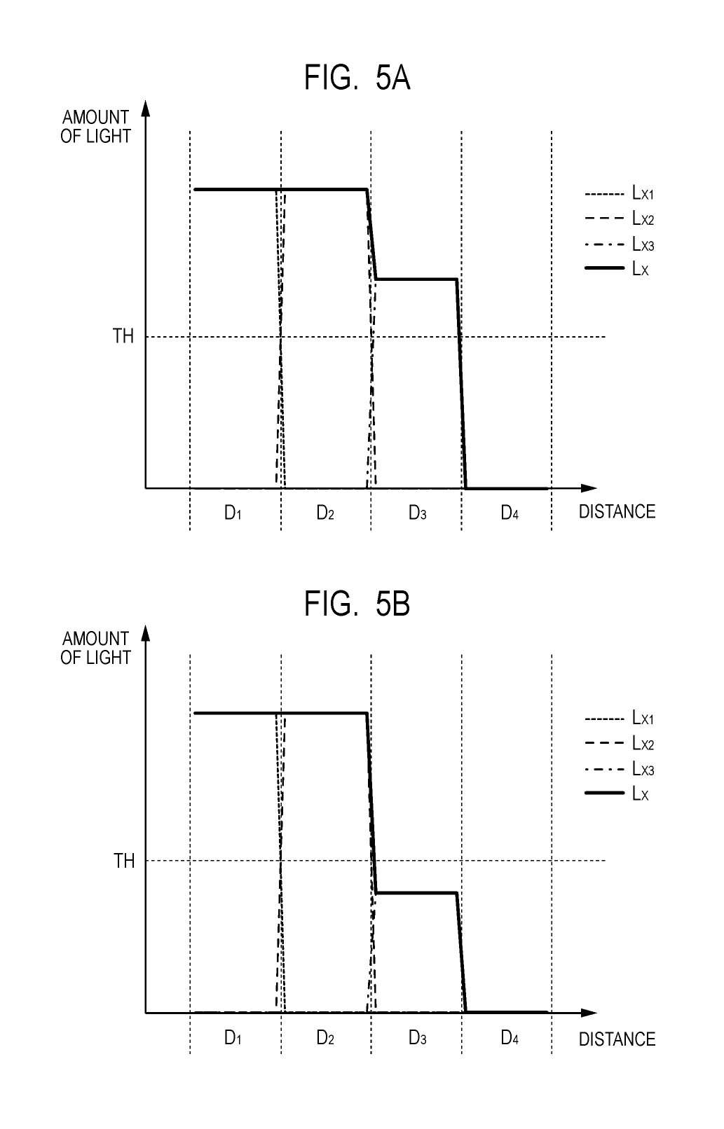

FIGS. 5A and 5B are graphs each of which describes a light amount distribution (light intensity distribution) of the light projected by each pixel at the manufacturing position when the image forming position is made to coincide with the manufacturing position. Namely, FIGS. 5A and 5B are the graphs in a case where a duty ratio indicating a ratio of the time of the ON state to the total time of the ON state and the OFF state is made different. More specifically, the duty ratio indicated by the graph of FIG. 5B is made larger than the duty ratio indicated by the graph of FIG. 5A.

Each of FIGS. 5A and 5B indicates a profile in a state that the light of each pixel 261 is imaged at the manufacturing position P_{A}. In a case where the pixels 261₁ and 261₂ are ON-controlled when the image forming position P_{S} of the light passing through the projection optical system 255 coincides with the manufacturing position P_{A}, the light amount distributions formed by the respective pixels 261₁ and 261₂ are light amount distributions L_{X1} and L_{X2} illustrated in FIGS. 5A and 5B. Since the pixel 261₄ is OFF-controlled, the light amount distribution is 0. Besides, the pixel 261₃ is duty-controlled, and a light amount distribution L_{X3} having a smaller amount of light (light intensity) than those of the light amount distributions L_{X1} and L_{X2} is given. As in FIGS. 5A and 5B, the amount of light of the light amount distribution L_{X3} is adjusted in accordance with the duty ratio. In the case where the image forming position P_{S} coincides with the manufacturing position P_{A}, the pixels 261i, 261₂, 261₃ and 261₄ are ON-controlled, so that manufacturing ranges (distances) in which the manufacture at the manufacturing position P_{A} can be performed are set as D₁, D₂, D₃ and D₄. Besides, a light amount distribution obtained by adding up (integrating) the light amount distributions L_{X1}, L_{X2} and L_{X3} is given as L_{X}.

Here, as described above, the photosetting resin material R_{A} has a threshold (light amount threshold) TH of the amount of light of the light to be cured. When the amount of light of the irradiated light reaches the threshold TH, the photosetting resin material R_{A} is cured. When the light of the light amount distributions L_{X1} and L_{X2} is irradiated to the manufacturing position P_{A}, the photosetting resin material R_{A} in the manufacturing ranges D₁ and D₂ can be cured.

On the other hand, when the light of the light amount distribution L_{X3} is irradiated to the manufacturing position P_{A}, even if the brightness modulation is performed by adjusting the duty ratio of the pixel 261₃, there is only that the entire manufacturing range D₃ is cured or not cured. That is, at the manufacturing position P_{A}, the accumulated light amount distribution L_{X} is given. However, even if the pixel 261₃ is duty-controlled, the part of the manufacturing range D₃ of the light amount distribution L_{X} exceeds the threshold TH as in FIG. 5A or falls below the threshold TH as in FIG. 5B. Therefore, the manufacture is performed with resolving power corresponding to the resolution of the image forming element.

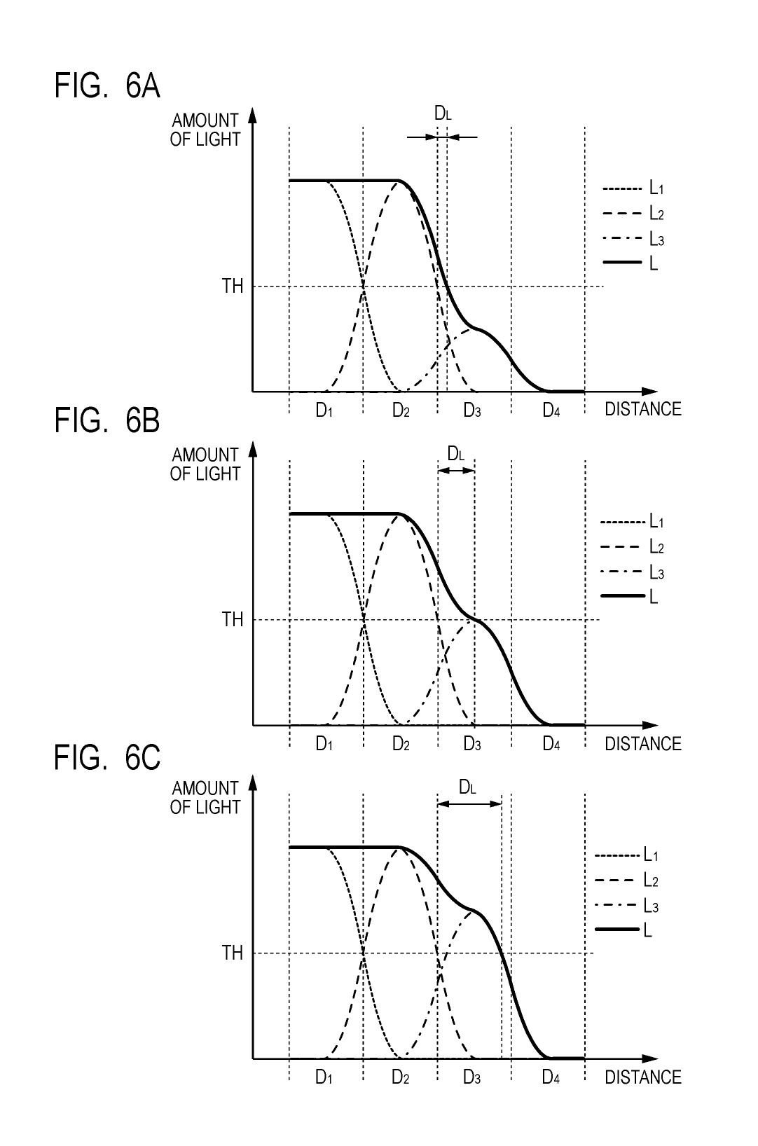

FIGS. 6A to 6C are graphs each of which describes a light amount distribution of the light projected by each pixel at the manufacturing position in a case where the duty ratio is changed when the image forming position is shifted with respect to the manufacturing position. Namely, FIGS. 6A to 6C are the graphs in a case where a shift amount of the image forming position with respect to the manufacturing position is made constant. Besides, FIGS. 6A to 6C are the graphs in the case where the duty ratio indicating the ratio of the time of the ON state to the total time of the ON state and the OFF state is made different. More specifically, in the graphs of FIGS. 6A to 6C, the duty ratio value is gradually increased in order of FIGS. 6A, 6B and 6C.

In a case where the pixels 261₁ and 261₂ are ON-controlled when the image forming position P_{S} of the light passing through the projection optical system 255 is set to be shifted in a direction parallel to the Z₁ direction with respect to the manufacturing position P_{A}, the light amount distributions formed by the respective pixels are light amount distributions L₁ and L₂ illustrated in FIGS. 6A to 6C. As illustrated in FIGS. 6A to 6C, in the profile (light amount distribution) of the light of each pixel 261, the projection region is expanded at the manufacturing position P_{A} as compared with the profiles of FIGS. 5A and 5B in the state that imaging is performed at the manufacturing position. The inclination of the profile of the light of each pixel 261 at the manufacturing position P_{A} is gentle (smaller inclination angle) as compared with the profiles illustrated in FIGS. 5A and 5B. That is, the projection region of the light which is the light amount distribution L₁ at the manufacturing position P_{A} is wider than the projection region of the light which is the light amount distribution L_{X1}, and this region overreaches (laps over) the adjacent manufacturing range D₂. Likewise, the projection region of the light which is the light amount distribution L₂ at the manufacturing position P_{A} is wider than the projection region of the light which is the light amount distribution L_{X2}, and this region overreaches (laps over) the adjacent manufacturing ranges D₁ and D₃. Since the pixel 261₄ is OFF-controlled, the light amount distribution is 0. Besides, the pixel 261₃ is duty-controlled, and a light amount distribution L₃ having a smaller amount of light than those of the light amount distributions L₁ and L₂ is given. The peak value of the light amount distribution L₃ can be adjusted by the duty ratio as in FIGS. 6A to 6C. Besides, a light amount distribution obtained by adding up (superposing) the light amount distributions L₁, L₂ and L₃ is given as L.

In the case of the light amount distribution L₂ of the present embodiment, the photosetting resin material R_{A} in its own manufacturing range D₂ can be cured even though the light overreaches the adjacent manufacturing range D₃. Further, since the light amount does not reach the threshold TH with only the light overreaching the adjacent manufacturing range D₃, even if the adjacent pixel 261₃ is OFF-controlled, the photosetting resin material R_{A} in the adjacent manufacturing range D₃ will not be cured.

In the present embodiment, when the pixel 261₃ adjacent to the pixel 261₂ is duty-controlled, the light amount distribution L₃ indicating halftone between the gradation at ON and the gradation at OFF is obtained at the manufacturing position P_{A}. Light of the light amount distribution L obtained by superposing the light amount distribution L₃ and the light amount distribution L₂ (the portion overreaching the manufacturing range D₃) is irradiated to the manufacturing range D₃. Therefore, in the duty control of the pixel 261₃, by adjusting the duty ratio indicating the ratio of the time of the ON state to the total time of the ON state and the OFF state, it is possible to control a range (width) DL to be photo-cured in the manufacturing range D₃. That is, it is possible to manufacture the manufactured object with resolving power higher than resolving power corresponding to the resolution of the image forming element 253.

Incidentally, the case where the pixels 261₁ and 261₂ are ON-controlled has been described as the example. However, the present invention is not limited to this. Namely, the duty control may be performed within a range which does not affect the manufacture in the manufacturing ranges D₁ and D₂.

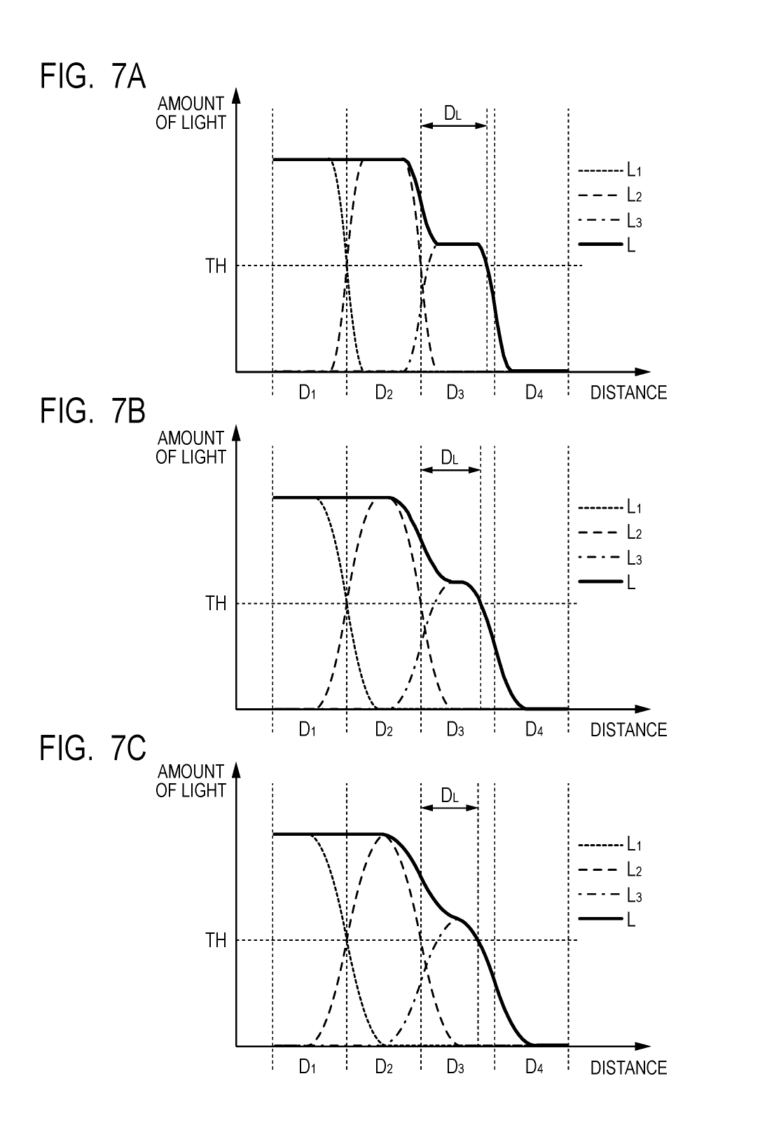

Here, the light amount distributions L₁ to L₃, i.e., the light amount distribution L also change in accordance with the shift amount of the image forming position P_{S} with respect to the manufacturing position P_{A}. FIGS. 7A to 7C are graphs each of which describes a light amount distribution of light projected by each pixel at the manufacturing position when a shift amount of the image forming position with respect to the manufacturing position is changed. Besides, FIGS. 7A to 7C are the graphs in the case where the duty ratio is constant. In the graphs of FIGS. 7A to 7C, the shift amount is increased in order of FIGS. 7A, 7B and 7C.

As illustrated in FIGS. 7A to 7C, as the shift amount of the image forming position P_{S} with respect to the manufacturing position P_{A} increases, the ranges of the light amount distributions L₁ to L₃ widen. As a result, the range (width) DL to be photo-cured in the manufacturing range D₃ becomes narrow. Therefore, the duty ratio may be set according to the shift amount of the image forming position P_{S}, i.e., a control amount of the driving mechanism 254. As just described, it is possible to finely control the range (width) DL to be photo-cured in the manufacturing range D₃ also by the control amount of the driving mechanism 254. That is, the range (width) DL to be photo-cured in the manufacturing range D₃ can be coarsely adjusted by the duty ratio and finely adjusted by the shift amount of the image forming position P_{S}.

It is preferable that the image forming position P_{S} is shifted in the Z₂ direction in which the dead zone DZ and the light transmitting member 212 exist. That is, if the image forming position P_{S} is within the dead zone DZ or the light transmitting member 212, the photosetting resin material R_{A} will not be cured at the relevant image forming position P_{S}.

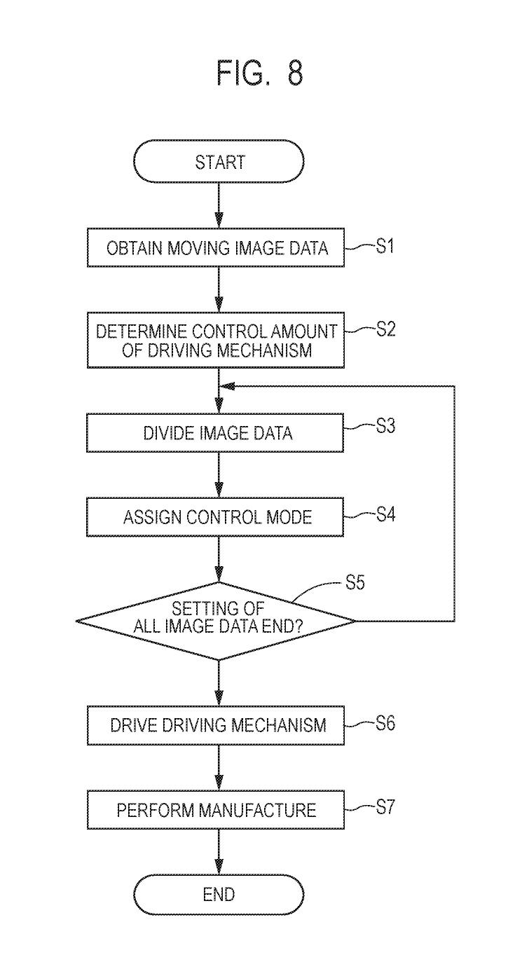

FIG. 8 is a flow chart for describing a manufacturing method of the manufactured object according to the embodiment. The CPU 301 of the controlling device 300 obtains the moving image data composed of a plurality of image data from the image processing apparatus 400 (S1).

Further, the CPU 301 determines the shift amount of the image forming position P_{S} with respect to the manufacturing position P_{A}, i.e., the control amount of the driving mechanism 254 (S2).

The CPU 301 divides the image data into the respective section regions corresponding to the respective pixels 261 of the image forming element 253 (S3).

The CPU 301 selects and assigns the control mode for controlling each of the pixels 261 of the image forming element 253 from among the ON control, the OFF control and the duty control, in accordance with the pixel data included in each section region (S4). More specifically, the CPU 301 selects the ON control when the pixel data in the section region is only pixel data indicating the manufacturing portion. Further, the CPU 301 selects the OFF control when the pixel data in the section region is only pixel data indicating the space portion. Furthermore, the CPU 301 selects the duty control when the pixel data in the section region includes the pixel data indicating the manufacturing portion and the pixel data indicating a portion not being the manufacturing portion.

In S4, the CPU 301 sets, according to the control amount of the driving mechanism 254, the duty ratio for the pixel 261 for which the duty control is performed, on the basis of the number of pixels or the pixel position of the pixel data indicating the manufacturing portion in the corresponding section region. More specifically, the CPU 301 sets, according to the light amount distribution of the projection region of another pixel overlapping the projection region of the target pixel, the duty ratio for the target pixel (pixel 261₃ in FIG. 4A) to be controlled to halftone, among the plurality of pixels 261. Here, in the explanation for the graphs of FIGS. 7A to 7C, only the adjacent pixel 261₂ affects the light amount distribution of the projection region of the pixel 261₃, but another pixel may exist in addition to this. That is, the duty ratio may be set based on addition (integration) of the light amount distributions of all the pixels extending to the manufacturing range D₃. By duty-controlling the pixel 261 based on this setting, the light output by the pixel 261 is controlled to halftone.

Next, the CPU 301 determines whether or not the control mode has been set for all the image data (S5). If there is remaining image data (S5: NO), the CPU returns the process to S3 to repeat the determination until the setting of the control mode is completed for all the image data (S5: YES).

The CPU 301 stores the data of the control mode of each pixel 261 corresponding to each image data in the ROM 303 in association with the control amount data of the moving mechanism 203. Incidentally, also the control amount data of the driving mechanism 254 determined in S2 is stored in the ROM 303.

Next, the CPU 301 performs setting such that the image forming position P_{S} of the light passing through the projection optical system 255 is being shifted in a direction parallel to the Z₁ direction (specifically, Z₂ direction) with respect to the manufacturing position P_{A} (S6). That is, based on the control amount data of the driving mechanism 254, the CPU 301 controls the driving mechanism 254 to shift the image forming position P_{S} with respect to the manufacturing position P_{A}.

Next, based on the data set in S1 to S5, the CPU 301 controls each part to manufacture the manufactured object W_{A} (S7). That is, the CPU 301 turns on the light source 251, and controls each pixel 261 of the image forming element 253 in the set control mode while moving the holding plate 202 in the Z₁ direction by the moving mechanism 203, thereby switching and projecting the image light. In S7, during each period in which each image light is projected, the CPU 301 controls the light output by the pixel 261 corresponding to the section region including the pixel data indicating the manufacturing portion and the pixel data indicating the space portion among the plurality of pixels 261, to halftone as described above.

As just described, since the manufacturing width at the edge of the manufacturing layer can be finely controlled by performing the brightness modulation by the duty control, it is possible to manufacture the manufactured object W_{A} with the resolving power higher than the resolving power corresponding to the resolution of the image forming element 253.

It should be noted that the present invention is not limited to the above embodiment, and many modifications are possible within the technical idea of the present invention. Besides, the effects described in the embodiment of the present invention are merely listed as most preferable effects resulting from the present invention. Namely, the effects of the present invention are not limited to those described in the embodiment of the present invention.

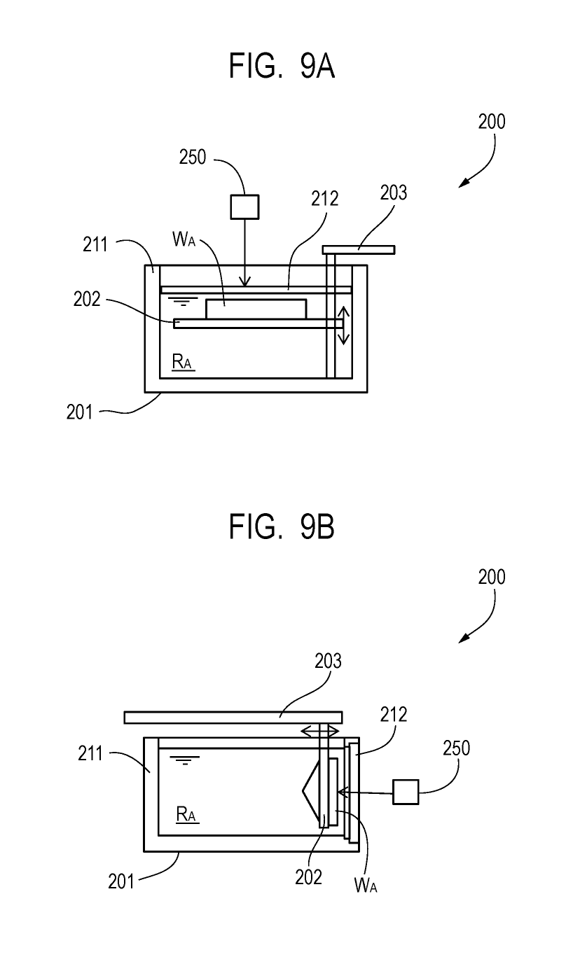

In the above embodiment, the case where the image light is introduced into the vessel 201 from the bottom portion of the vessel 201 has been described. However, the present invention is not limited to this. FIGS. 9A and 9B are schematic diagrams respectively for describing other examples of the manufacturing unit of the additive manufacturing apparatus according to the embodiment. For example, as illustrated in FIG. 9A, the image light may be introduced from the top of the vessel 201 into the vessel 201. Alternatively, as illustrated in FIG. 9B, the image light may be introduced from the side of the vessel 201 into the vessel 201. In the case of FIG. 9A, the light transmitting member 212 may be disposed on the top of the vessel 201 and the holding plate 202 may be moved downward to manufacture the manufactured object W_{A}. In the case of FIG. 9B, the light transmitting member 212 may be disposed on the side of the vessel 201 and the holding plate 202 may be moved in a direction opposite to the direction in which the holding plate 202 exists, to manufacture the manufactured object W_{A}. Incidentally, in the case of FIG. 9A, the light transmitting member 212 may be omitted. In this case, the opening in the top of the vessel serves as the light transmitting portion.

In the above embodiment, the case where the image forming position is moved with respect to the manufacturing position by moving the image forming element 253 by the driving mechanism 254 has been described. However, the present invention is not limited to this. For example, only the projection optical system 255 may be moved, or both the image forming element 253 and the projection optical system 255 may be moved. Besides, although the case where one of the projection optical system 255 and the image forming element 253 is moved by using the driving mechanism 254 has been described, the projection optical system 255 and the image formation element 253 may be fixedly disposed such that the image forming position is being shifted from the manufacturing position.

In the above embodiment, the case where the dead zone is formed by oxygen has been described. However, the present invention is not limited to this. Namely, a demolding (releasing) layer composed of a demolding agent different from the photosetting resin material may be disposed between the photosetting resin material and the light transmitting portion.

In the above embodiment, the case where the image forming position is shifted with respect to the manufacturing position as means for blurring the light from each pixel at the manufacturing position (expanding the light projection region) has been described. However, the present invention is not limited to this. For example, the projection optical system (projection lens) may be formed so that the light from each pixel is blurred at the manufacturing position. Further, a member for diffusing light of a low-pass filter or the like may be inserted in the optical path so that the light is blurred at the manufacturing position. In any case, in the profile (light amount distribution) of the light of each pixel 261, the projection region is expanded at the manufacturing position P_{A} as compared with the profiles of FIGS. 5A and 5B in the state that the imaging is performed at the manufacturing position. The inclination of the profile of the light of each pixel 261 at the manufacturing position P_{A} is gentle (smaller inclination angle) as compared with the profiles illustrated in FIGS. 5A and 5B.

The present invention can be realized also by a process in which a program for realizing one of more functions of the above embodiment is supplied to a system or an apparatus via a network or a storage medium and one or more processors in the system or the apparatus read and execute the supplied program. Besides, the present invention can be realized also by a circuit (e.g., ASIC) of realizing one or more functions of the above embodiment.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An additive manufacturing apparatus comprising:
a light source;
a vessel configured to have a light transmitting portion through which light of the light source is transmitted, and store a photosetting resin material to be cured by the light of the light source;
an image forming element configured to form image light corresponding to image data, from the incident light from the light source;
a projection optical system configured to project the image light on a manufacturing position inside the vessel through the light transmitting portion;
a moving member configured to move a manufacturing layer cured by the image light at the manufacturing position, in a separation direction away from the light transmitting portion; and
a controlling unit configured to control the image forming element, wherein
the image forming element is configured to have a plurality of pixels in which light to be output to the projection optical system can be adjusted individually,
a profile of the light of each of the pixels passing through the projection optical system is set to a state that a projection region is expanded at the manufacturing position as compared with a profile in a state that imaging is performed at the manufacturing position,
the controlling unit is configured to divide the image data having resolution higher than resolution of the image forming element into a section region corresponding to each of the pixels of the image forming element, and
in each period that the image light is projected, the controlling unit is configured to control, to halftone, the light output from, among the plurality of pixels, the pixel corresponding to the section region including pixel data indicating a manufacturing portion and pixel data indicating a portion not the manufacturing portion.

2. The additive manufacturing apparatus according to claim 1, wherein an image forming position of the light passing through the projection optical system is set to a state being shifted in a direction parallel to the separation direction with respect to the manufacturing position, such that the projection region is expanded at the manufacturing position in the profile of the light of each of the pixels passing through the projection optical system, as compared with the profile in the state that the imaging is performed at the manufacturing position.

3. The additive manufacturing apparatus according to claim 1, wherein
in each of the pixels of the image forming element, an ON state that the incident light is output to the projection optical system and an OFF state that the incident light is not output to the projection optical system can be switched individually, and
the controlling unit is configured to control the light to halftone by controlling to alternately switch the ON state and the OFF state.

4. The additive manufacturing apparatus according to claim 3, wherein the image forming element is a DMD (digital micromirror device) element.

5. The additive manufacturing apparatus according to claim 3, wherein the controlling unit is configured to set, with respect to the pixel to be controlled to halftone, a duty ratio indicating a ratio of time of the ON state to a total time of the ON state and the OFF state, on the basis of the number of pixels or a pixel position of the pixel data indicating the manufacturing portion included in the corresponding section region.

6. The additive manufacturing apparatus according to claim 5, wherein the controlling unit is configured to set the duty ratio for, among the plurality of pixels, the target pixel to be controlled to halftone, in accordance with a light amount distribution of a projection region of another pixel overlapping a projection region of the target pixel.

7. The additive manufacturing apparatus according to claim 1, further comprising a driving mechanism configured to move at least one of the image forming element and the projection optical system, and shift the image forming position of the light passing through the projection optical system in a direction parallel to the separation direction with respect to the manufacturing position, wherein
the controlling unit is configured to control a shift amount the image forming position by the driving mechanism with respect to the manufacturing position, such that the projection region is expanded at the manufacturing position in the profile of the light of each of the pixels passing through the projection optical system, as compared with the profile in the state that the imaging is performed at the manufacturing position.

8. The additive manufacturing apparatus according to claim 7, wherein the driving mechanism is configured to move the image forming element.

9. The additive manufacturing apparatus according to claim 7, wherein the driving mechanism is configured to have a piezoelectric element.

10. A manufactured object manufacturing method, in which a photosetting resin material to be cured by light of a light source is stored in a vessel having a light transmitting portion, an image forming element which has a plurality of pixels in which light to be output to an projection optical system can be adjusted individually is controlled by a controlling unit to form image light corresponding to sequentially switched image data from the incident light from the light source, the image light is projected by the projection optical system on a manufacturing position inside the vessel through the light transmitting portion, and a three-dimensional manufactured object is manufactured while moving, by a moving member, a manufacturing layer cured at the manufacturing position in a separation direction away from the light transmitting portion, the manufactured object manufacturing method comprising:
setting a profile of the light of each of the pixels passing through the projection optical system to a state that a projection region is expanded at the manufacturing position as compared with a profile in a state that imaging is performed at the manufacturing position;
dividing, by the controlling unit, the image data having resolution higher than resolution of the image forming element into a section region corresponding to each of the pixels of the image forming element; and
in each period that the image light is projected, controlling, by the controlling unit, the light output from, among the plurality of pixels, the pixel corresponding to the section region including pixel data indicating a manufacturing portion and pixel data indicating space, to halftone.

11. A non-transitory computer-readable recording medium which records thereon a program for causing to perform steps of a manufactured object manufacturing method, in which a photosetting resin material to be cured by light of a light source is stored in a vessel having a light transmitting portion, an image forming element which has a plurality of pixels in which light to be output to an projection optical system can be adjusted individually is controlled by a controlling unit to form image light corresponding to image data to be sequentially switched from the incident light from the light source, the image light is projected by the projection optical system on a manufacturing position inside the vessel through the light transmitting portion, and a three-dimensional manufactured object is manufactured while moving, by a moving member, a manufacturing layer cured at the manufacturing position in a separation direction away from the light transmitting portion, the manufactured object manufacturing method comprising:
setting a profile of the light of each of the pixels passing through the projection optical system to a state that a projection region is expanded at the manufacturing position as compared with a profile in a state that imaging is performed at the manufacturing position;
dividing, by the controlling unit, the image data having resolution higher than resolution of the image forming element into a section region corresponding to each of the pixels of the image forming element; and
in each period that the image light is projected, controlling, by the controlling unit, the light output from, among the plurality of pixels, the pixel corresponding to the section region including pixel data indicating a manufacturing portion and pixel data indicating space, to halftone.
